(19) United States
(12) Patent Application Publication
(10) Pub. No.: US 2015/0219386 A1
(43) Pub. Date: Aug. 6, 2015

(54) Evaporator Coil Mounted Electric Heater Assembly

(71) Applicant: Trane International Inc., Piscataway, NJ (US)

(72) Inventors: Leslie Lynn Zinger, Bullard, TX (US); Thomas Eddie Kennedy, Tyler, TX (US); Brad Lynn Kersh, Flint, TX (US)

(21) Appl. No.: 14/577,874

(22) Filed: Dec. 19, 2014

Related U.S. Application Data
(60) Provisional application No. 61/935,212, filed on Feb. 3, 2014.

(51) Int. Cl. F25D 21/08; B23P 15/26

(52) U.S. Cl. CPC F25D 21/08; B23P 15/26

(57) ABSTRACT

An air handling unit used in a heating, ventilation, and/or air conditioning (HVAC) system may include an enclosure having an air inlet, an air outlet, and a fluid duct that extends from the air inlet to the air outlet, a heater assembly comprising a base plate comprising an inner surface and an outer surface and that is configured to form at least a portion of the fluid duct, and a heat exchanger assembly configured to selectively receive the heater assembly between a left heat exchanger slab and a right heat exchanger slab. The base plate of the heater assembly may be configured to carry a plurality of electrical components on the outer surface of the base plate and may be configured to carry a plurality of heating elements on an inner surface that are disposed within the fluid duct and configured to heat an airflow passing through the fluid duct.

### CROSS-REFERENCE TO RELATED APPLICATIONS

The present application claims priority under 35 U.S.C. 119(e) to U.S. Provisional Patent Application No. 61/935,212 filed on Feb. 3, 2014 by Zinger, et. al. and entitled “Evaporator Coil Mounted Electric Heater Assembly,” the disclosure of which is hereby incorporated by reference in its entirety.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Heating, ventilation, and/or air conditioning (HVAC) systems may generally comprise an air handling unit (AHU) that contains a heat exchanger, a blower, and a plurality of other structural and/or electrical components disposed within a cabinet having an air return opening at one end and an air supply opening at an opposing end. As a result, some AHU's that serially locate various components between the return opening and the air supply may be undesirably large and unfit for applications with limited space availability.

### SUMMARY

In some embodiments of the disclosure, an air handling unit is disclosed as comprising an enclosure comprising: an air inlet, an air outlet, and a fluid duct that extends from the air inlet to the air outlet; a heater assembly comprising a base plate that comprises an inner surface and an outer surface and that is configured to form at least a portion of the fluid duct; and a heat exchanger assembly configured to selectively receive the heater assembly.

In other embodiments of the disclosure, a method of forming a fluid duct in an air handling unit is disclosed as comprising: providing an enclosure comprising an air inlet, an air outlet, and a fluid duct that extends from the air inlet to the air outlet; providing a heater assembly comprising a base plate that comprises an inner surface and an outer surface and that is configured to form at least a portion of a fluid duct in an air handling unit; and providing a heat exchanger assembly configured to selectively receive the heater assembly.

### BRIEF DESCRIPTION OF THE DRAWINGS

For a more complete understanding of the present disclosure and the advantages thereof, reference is now made to the following brief description, taken in connection with the accompanying drawings and detailed description:

FIG. 1 is a schematic view of an AHU according to an embodiment of the disclosure;

FIG. 2 is a front orthogonal view of an AHU according to an embodiment of the disclosure;

FIG. 3 is a partial exploded oblique view of a heat exchanger assembly and a heater assembly of the AHU of FIG. 2 according to an embodiment of the disclosure; and

FIG. 4 is a flowchart of a method of forming a fluid duct in an AHU according to embodiments of the disclosure.

### DETAILED DESCRIPTION

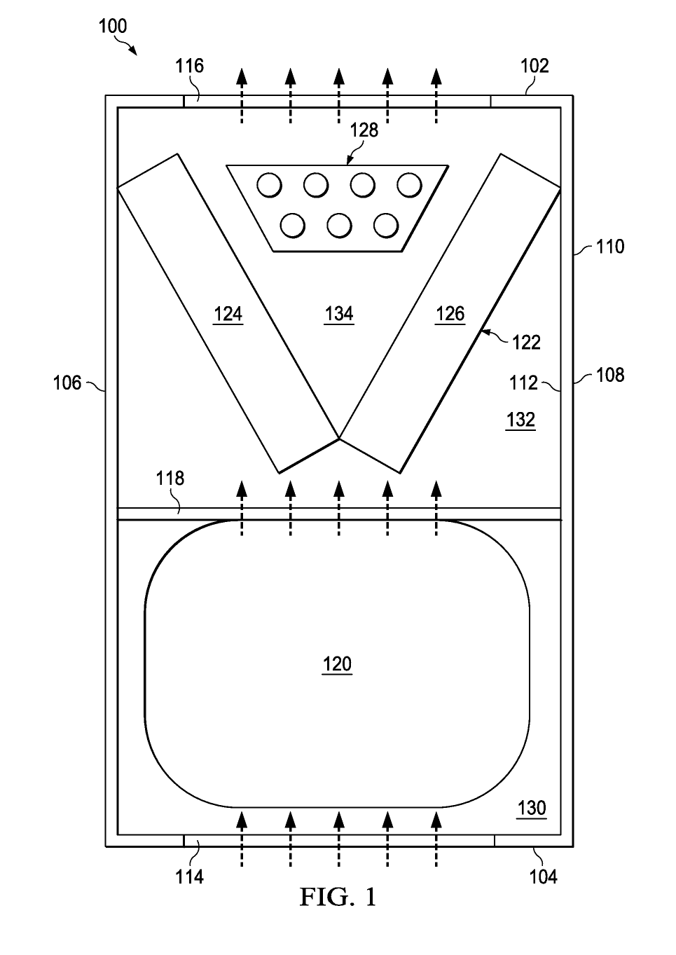

Referring now to FIG. 1, a schematic view of an AHU 100 is shown according to embodiments of the disclosure. AHU 100 may generally be described as comprising a top side 102, a bottom side 104, a left side 106, and a right side 108. AHU 100 may also comprise a front side and a back side that substantially opposes the shown front side of the AHU 100. It will be appreciated that AHU 100 may be installed in various orientations, and such directional descriptions of AHU 100 are provided to assist the reader in understanding the physical orientation of the various component parts of the AHU 100. Accordingly, such directional descriptions of AHU 100 shall not be interpreted as indicating absolute locations and/or directional limits of the AHU 100, but shall instead indicate that a plurality of described and/or labeled directional descriptions shall provide general directional orientation to the reader so that directionality may be easily followed. Furthermore, the component parts and/or assemblies of the AHU 100 may be described as generally having top, bottom, left, and right sides which should be understood as being consistent in orientation with the top side 102, bottom side 104, left side 106, and right side 108 of the AHU 100.

AHU 100 may generally comprise a double-walled construction that comprises an outer shell 110 and an inner wall 112. The outer shell 110 may generally cover the back side, the left side 106, and the right side 108 of the AHU 100. In some embodiments, the outer shell 110 may also cover at least a portion of the top side 102 and/or the bottom side 104. The inner wall 112 may generally form a four-walled fluid duct through the AHU 100 and may generally extend from an air inlet 114 to an air outlet 116 of the AHU 100. The air inlet 114 may generally be associated with a most upstream location with respect to an airflow through the AHU 100, while the air outlet 116 may generally be associated with a most downstream location with respect to an airflow through the AHU 100. As with the physical directional descriptions, such upstream and downstream directional descriptions are meant to assist the reader in understanding the physical orientation of the various component parts of the AHU 100 and shall not be interpreted as indicating absolute locations and/or directional limits of the AHU 100.

The AHU 100 may also comprise a plurality of selectively removable components disposed within the fluid duct of the AHU 100 that may divide the AHU 100 into various pressure zones. The AHU 100 may generally comprise a blower assembly 120 that may be carried by the AHU 100 and that may be selectively removable from the AHU 100. The blower assembly 120 may also be disposed at an upstream end of the AHU 100 substantially adjacent to the air inlet 114. The blower assembly 120 may generally comprise an electrically powered, motor driven rotatable blower that may be configured to deliver an airflow through the fluid duct of the AHU 100. In some embodiments, the blower assembly 120 may be mounted to a partition 118 of the AHU 100. However, in some embodiments, the partition 118 may be a part of the blower assembly 120, such as a blower deck and/or a drain pan. In some embodiments, the partition 118 and/or a portion of the blower assembly 120 may form a fluid tight seal with the inner wall 112 of the AHU 100, such that the partition 118 and/or the portion of the blower assembly 120 divides the AHU 100 into a first pressure zone 130 that is located generally adjacent to and substantially upstream of the partition 118, the blower assembly 120, and a second pressure zone 132 that is located substantially downstream from the partition 118 and the blower assembly 120.

The AHU 100 may further comprise a heat exchanger assembly 122 that may also be disposed within the fluid duct of the AHU 100. The heat exchanger assembly 122 may also be carried by the AHU 100 and may also be selectively removable from the AHU 100. Additionally, the heat exchanger assembly 122 may generally be disposed downstream from the blower assembly 120. In some embodiments, an upper end of the heat exchanger assembly 122 may be disposed substantially adjacent to the air outlet 116 of the AHU 100. The heat exchanger assembly 122 may generally comprise a so-called V-frame heat exchanger that comprises a left slab 124 and a right slab 126. The heat exchanger assembly 122 may be configured to promote heat transfer between a refrigerant flowing through the left and right slabs 124, 126 of the heat exchanger assembly 122 and an airflow flowing through the AHU 100. In some embodiments, the heat exchanger assembly 122 may, however, be referred to as a so-called inverted A-frame heat exchanger. In some embodiments, an upper end of the left and right slabs 124, 126 of the heat exchanger assembly 122 may form a fluid tight seal with the inner wall 112 of the AHU 100, while a front wall and a rear wall disposed between the left and right slabs 124, 126 may form a fluid tight seal at the front and rear of the heat exchanger assembly 122, such that the heat exchanger assembly 122 divides the AHU 100 into the second pressure zone 132 that is located substantially downstream from the partition 118 and the blower assembly 120 and substantially upstream from the heat exchanger assembly 122 and a third pressure zone 134 that is located substantially downstream from the heat exchanger assembly 122. In some embodiments, the front wall and rear wall of the heat exchanger assembly 122 may also form at least a portion of the fluid duct in the third pressure zone 134 of the AHU 100.

The AHU 100 may also comprise a heater assembly 128 that may be carried by the heat exchanger assembly 122 and that may be selectively removable from the heat exchanger assembly 122 and the AHU 100. The heater assembly 128 may generally be disposed downstream from the heat exchanger assembly 122 and within the third pressure zone 134 created by the heat exchanger assembly 122. The heater assembly 128 may also be disposed between the left slab 124 and the right slab 126 of the heat exchanger assembly 122 such that the heater assembly 128 may be at least partially bounded laterally on a left side by the left slab 124 of the heat exchanger assembly 122 and at least partially bounded laterally on a right side by the right slab 126 of the heat exchanger assembly 122. In some embodiments, an upper end of the heater assembly 128 may be located further upstream with respect to an airflow through the AHU 100 than the upper most ends of both the left slab 124 and the right slab 126 of the heat exchanger assembly 122, so that substantially the entire heater assembly 128 is bounded by the left slab 124 on a left side and by the right slab 126 on the right side. Additionally, in some embodiments, the heater assembly 128 may be disposed substantially adjacent to the air outlet 116 of the AHU 100. By locating the heater assembly 128 between the left slab 124 and the right slab 126 of the heat exchanger assembly 122, the heater assembly 128 may replace at least a portion of the front wall to form at least a portion of the fluid duct in the third pressure zone 134.

The heater assembly 128 may generally comprise a plurality of electrically-powered heating elements that may generally be configured to provide heat to an airflow flowing through the AHU 100. In some embodiments, however, the heater assembly 128 may comprise heating elements that suitably heat a surrounding airflow but that are not primarily electrically-powered (i.e., gas burners). It will be appreciated that locating the heater assembly 128 between the left slab 124 and the right slab 126 of the heat exchanger assembly 122 may reduce the height of and/or the volumetric space occupied by the AHU 100 than if the heater assembly 128 were disposed further downstream from the heat exchanger assembly 122 such that no portion of the heater assembly 128 was bounded laterally by the slabs 124, 126 of the heat exchanger assembly 122.

In operation, and when the AHU 100 is fully assembled with the blower assembly 120, the heat exchanger assembly 122, and the heater assembly 128, an airflow may generally follow a path through the AHU 100 along which air may enter the first pressure zone 130 of the AHU 100 through the air inlet 114 located in the bottom side 104 of the AHU 100 where the air may successively encounter the blower assembly 120. The air may then be passed by the blower assembly 120 through the partition 118 and into the second pressure zone 132 where the air may successively encounter the heat exchanger assembly 122. The air may then pass through the heat exchanger assembly 122 to the third pressure zone 134, where the air may then encounter the heater assembly 128 and then successively exit the AHU 100 through the air outlet 116 located in the top side 102 of the AHU 100.

As previously stated, the various pressure zones 130, 132, 134 may be defined by the various components of the AHU 100 as an airflow flows through the fluid duct of the AHU 100. Most notably, it can be seen that when the blower assembly 120 is installed into the AHU 100, the partition 118 generally provides a zone boundary between a first pressure zone 130 of the AHU 100 and a second pressure zone 132 of the AHU 100. The first pressure zone 130 may generally be associated with the air inlet 114 and/or air input ports of the blower assembly 120 while the second pressure zone 132 may generally be associated with an output of the blower assembly 120 and which, in this embodiment, may generally be associated with an upstream portion of the heat exchanger assembly 122. The heat exchanger assembly 122 may generally provide a zone boundary between the second pressure zone 132 and a third pressure zone 134. The second pressure zone 132 may generally be associated with an upstream portion of the heat exchanger assembly 122, while the third pressure zone 134 may generally be associated with a downstream portion of the heat exchanger assembly 122, the heater assembly 128, and/or the air outlet 116.

The blower assembly 120 may generally create a relatively lower pressure at or near the air inlet 114 in the first pressure zone 130 as compared to a surrounding environmental pressure. As the blower assembly 120 passes air through the partition 118, the airflow entering the second pressure zone 132 may generally produce a relatively higher pressure as compared to the first pressure zone 130. Additionally, a pressure differential may be created by passing the airflow through the heat exchanger assembly 122, and thus, the airflow may generally comprise an overall lower pressure in the third pressure zone 134 as compared to the second pressure zone 132. It will be appreciated that in some embodiments, the AHU 100 may be suitable for use in residential applications such as a heating and/or air conditioning system in an apartment, condominium, dwelling, or house. In other embodiments, however, AHU 100 may be used in commercial applications such as an HVAC system in a commercial, public, or industrial building or facility, or suitable other type of building or facility that distributes conditioned air.

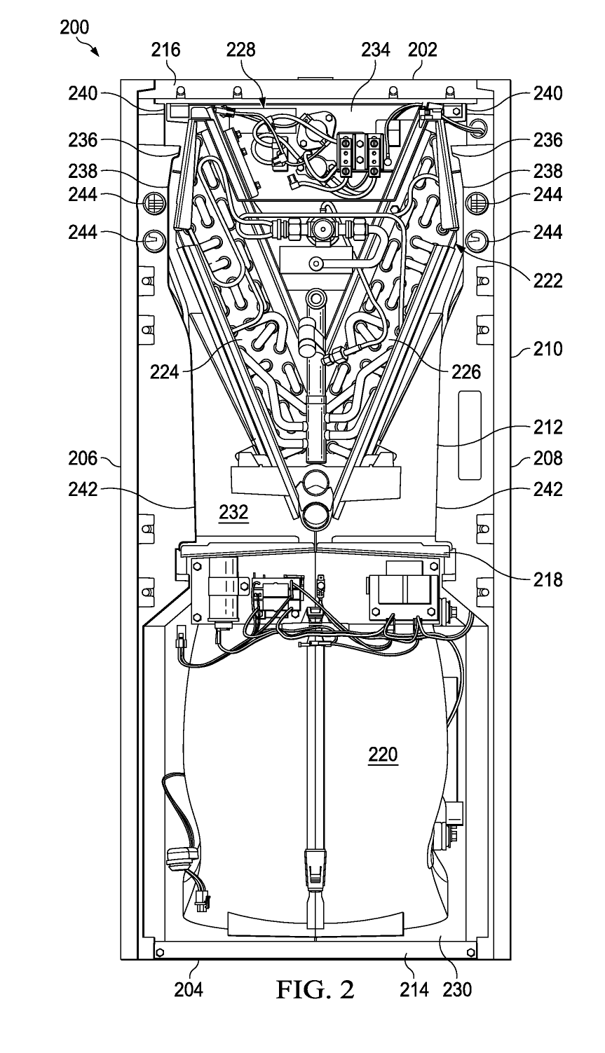

Referring now to FIG. 2, an orthogonal front view of an AHU 200 is shown according to an embodiment of the disclosure. It will be appreciated that AHU 200 may be substantially similar to AHU 100. AHU 200 may generally be described as comprising a top side 202, a bottom side 204, a left side 206, and a right side 208. AHU 200 may also comprise a front side and a back side that substantially opposes the shown front side of the AHU 200. It will be appreciated that AHU 200 may be installed in various orientations, and such directional descriptions of AHU 200 are provided to assist the reader in understanding the physical orientation of the various component parts of the AHU 200. Accordingly, such directional descriptions of AHU 200 shall not be interpreted as indicating absolute locations and/or directional limits of the AHU 200, but shall instead indicate that a plurality of described and/or labeled directional descriptions shall provide general directional orientation to the reader so that directionality may be easily followed. Furthermore, the component parts and/or assemblies of the AHU 200 may be described as generally having top, bottom, left, and right sides which should be understood as being consistent in orientation with the top side 202, bottom side 204, left side 206, and right side 208 of the AHU 200.

AHU 200 may generally comprise a double-walled construction that comprises an outer shell 210 and an inner wall 212. The outer shell 210 may generally cover the back side, the left side 206, and the right side 208 of the AHU 200. In some embodiments, the outer shell 210 may also cover at least a portion of the top side 202 and/or the bottom side 204. The inner wall 212 may generally form a four-walled fluid duct through the AHU 200 and that may generally extend from an air inlet 214 to an air outlet 216 of the AHU 200. The air inlet 214 may generally be associated with a most upstream location with respect to an airflow through the AHU 200, while the air outlet 216 may generally be associated with a most downstream location with respect to an airflow through the AHU 200. As with the physical directional descriptions, such upstream and downstream directional descriptions are meant to assist the reader in understanding the physical orientation of the various component parts of the AHU 200 and shall not be interpreted as indicating absolute locations and/or directional limits of the AHU 200.

In some embodiments, the inner wall 212 may comprise an integral rail 236 disposed on each of the left side 206 and the right side 208 of the AHU 200. The integral rails 236 may protrude inwardly from the remainder of the respective sides of the inner wall 212 so that complementary shaped structures of a portion of a heat exchanger assembly 222 may be slidably received by and/or retained by the integral rail 236 on each respective left and right sides 206, 208 of the AHU 200. The inner wall 212 of the AHU 200 may also comprise a mounting channel 240 disposed on each of the left and right sides 206, 208 of the AHU 200. In some embodiments, the mounting channels 240 may generally form a concavity that is open towards the interior of the AHU 200. Additionally, the mounting channels 240 may be integrally formed with the inner wall 212 and bounded on a bottom and/or downstream side with respect to an airflow by the protruding integral rails 236. Furthermore, the mounting channels 240 may be configured to slidably receive at least a portion of the heat exchanger assembly 222.

The AHU 200 may also comprise a portion of the inner wall 212 that forms at least a portion of a drain pan 238 on each of the left and right sides of the inner wall 212 of the AHU 200. In some embodiments, the drain pans 238 may comprise a concavity open towards the interior of the AHU 200 and may generally be bounded at least partially on an upstream side by the integral rails 236 on each of the left and right sides 206, 208 of the AHU 200. It will be appreciated that each of the left and right sides of the inner wall 212 may comprise a sloped portion 242 that is sloped from a bottom side of the drain pans 238 so that the bottom of the inner wall 212 that is located closest to a partition 218 of the AHU 200 protrudes further inward than the remainder of the inner wall 212 that is located further downstream and adjacent to the drain pans 238. It will be appreciated that when in operation, the sloped portions 242 and the integral drain pans 238 formed in the inner wall 212 may serve as a condensate drain pan of the AHU 200 and may cooperate with an airflow through the AHU 200 to direct condensation to a plurality of drain tubes 244 formed in the inner wall 212 of the AHU 200.

It will be appreciated that the space between the outer shell 210 and the inner wall 212 may be referred to as a wall space. In some embodiments, the wall space of the AHU 200 may be at least partially filled with an insulating material. More specifically, in some embodiments, polyurethane foam may at least partially fill the AHU 200 wall space. At least partially filling the wall space of the AHU 200 may increase a structural integrity of the AHU 200, may increase a thermal resistance of the AHU 200 between the interior of the AHU 200 and the exterior of the AHU 200, may decrease air leakage from the AHU 200, and may reduce and/or eliminate the introduction of volatile organic compounds (VOCs) into breathing air attributable to the AHU 200. Such a reduction in VOC emission by the AHU 200 may be attributable to the lack of and/or reduced use of traditional fiberglass insulation within the AHU 200 made possible by the insulative properties provided by the polyurethane foam within the wall space.

While the AHU 200 is depicted as a single cabinet structure, it will be appreciated that in some embodiments, the AHU 200 may comprise a modular construction that may be assembled from separate modular cabinets comprising complimentary profiles that may be configured to substantially adjoin to form a single modular structure that comprises the AHU 200. The AHU 200 may generally be constructed from metal, plastic, and/or a composite material. In some embodiments, the AHU 200 may be constructed of a sheet molding compound (SMC). The SMC may be chosen for its ability to meet the primary requirements of equipment and/or safety certification organizations and/or its relatively rigid cleanable surfaces that are resistant to mold growth and compatible with the use of antimicrobial cleaners. Further, the polyurethane foam used to fill the wall space of the AHU 200 may comprise refrigerant and/or pentane to enhance the thermal insulating characteristics of the foam. Of course, in alternative embodiments, any other suitable material may be used to form the structure of the AHU 200.

The AHU 200 may also comprise a plurality of selectively removable components disposed within the fluid duct of the AHU 200 that may divide the AHU 200 into various pressure zones. The AHU 200 may generally comprise a blower assembly 220 that may be carried by the AHU 200 and that may be selectively removable from the AHU 200. The blower assembly 220 may also be disposed at an upstream end of the AHU 200 substantially adjacent to the air inlet 214. The blower assembly 220 may generally comprise an electrically powered, motor driven rotatable blower that may be configured to deliver an airflow through the fluid duct of the AHU 200. In some embodiments, the blower assembly 220 may be mounted to a partition 218 of the AHU 200. However, in some embodiments, the partition 218 may be a part of the blower assembly 220, such as a blower deck and/or a drain pan. In some embodiments, the partition 218 and/or a portion of the blower assembly 220 may form a fluid tight seal with the inner wall 212 of the AHU 200, such that the partition 218 and/or the portion of the blower assembly 220 divides the AHU 200 into a first pressure zone 230 that is located generally adjacent to and substantially upstream of the partition 218 and a second pressure zone 232 that is located substantially downstream from the partition 218 and the blower assembly 220.

The AHU 200 may further comprise a heat exchanger assembly 222 that may also be disposed within the fluid duct of the AHU 200. The heat exchanger assembly 222 may also be carried by the AHU 200 and may also be selectively removable from the AHU 200. In some embodiments, the heat exchanger assembly 222 may be slidably received by the mounting channels 240 and configured to interact with and/or be retained by the integral rails 236 formed in the inner wall 212. Additionally, the heat exchanger assembly 222 may generally be disposed downstream from the blower assembly 220. In some embodiments, an upper end of the heat exchanger assembly 222 may be disposed substantially adjacent to the air outlet 216 of the AHU 200. The heat exchanger assembly 222 may generally comprise a so-called V-frame heat exchanger that comprises a left slab 224 and a right slab 226 and that may be configured to promote heat transfer between a refrigerant flowing through the left and right slabs 224, 226 of the heat exchanger assembly 222 and an airflow flowing through the AHU 200. In some embodiments, the heat exchanger assembly 222 may, however, be referred to as a so-called inverted A-frame heat exchanger. In some embodiments, an upper end of the left and right slabs 224, 226 of the heat exchanger assembly 222 may form a fluid tight seal with the inner wall 212 of the AHU 200, while a front wall and a rear wall disposed between the left and right slabs 224, 226 form a fluid tight seal at the front and rear of the heat exchanger assembly 222, such that the heat exchanger assembly 222 divides the AHU 200 into the second pressure zone 232 that is located substantially downstream from the partition 218 and the blower assembly 220 and substantially upstream from the heat exchanger assembly 222 and a third pressure zone 234 that is located substantially downstream from the heat exchanger assembly 222. In some embodiments, the front wall and rear wall of the heat exchanger assembly 222 may also form at least a portion of the fluid duct in the third pressure zone 234 of the AHU 200.

The AHU 200 may also comprise a heater assembly 228 that may be carried by the heat exchanger assembly 222 and that may be selectively removable from the heat exchanger assembly 222 and the AHU 200. The heater assembly 228 may generally be disposed downstream from the heat exchanger assembly 222 and within the third pressure zone 234 created by the heat exchanger assembly 222. In some embodiments, the heater assembly 228 may also be disposed between the left slab 224 and the right slab 226 of the heat exchanger assembly 222 such that at least a portion of the heater assembly 228 may be bounded laterally on a left side by the left slab 224 of the heat exchanger assembly 222 and bounded laterally on a right side by the right slab 226 of the heat exchanger assembly 222. In some embodiments, the heater assembly 228 may be disposed substantially in a downstream direction and received substantially between the left slab 224 and the right slab 226 of the heat exchanger assembly 222, such that an upper end of the heater assembly 228 may be located further upstream with respect to an airflow through the AHU 200 than the upper most ends of both the left slab 224 and the right slab 226 of the heat exchanger assembly 222. Additionally, in some embodiments, the heater assembly 228 may be disposed substantially adjacent to the air outlet 216 of the AHU 200. By locating the heater assembly 228 between the left slab 224 and the right slab 226 of the heat exchanger assembly 222, the heater assembly 228 may replace at least a portion of the front wall of the heat exchanger assembly 222 and form at least a portion of the fluid duct in the third pressure zone 234.

The heater assembly 228 may generally comprise a plurality of electrically-powered heating elements that may generally be configured to provide heat to an airflow flowing through the AHU 200. In some embodiments, however, the heater assembly 228 may comprise heating elements that suitably heat a surrounding airflow but that are not primarily electrically-powered (i.e., gas burners). It will be appreciated that locating the heater assembly 228 between the left slab 224 and the right slab 226 of the heat exchanger assembly 222 may allow a reduced height of and/or the volumetric space occupied by the AHU 200 as compared to if the heater assembly 228 were disposed further downstream from the heat exchanger assembly 222 such that no portion of the heater assembly 228 was bounded laterally by the slabs 224, 226 of the heat exchanger assembly.

In operation, and when the AHU 200 is fully assembled with the blower assembly 220, the heat exchanger assembly 222, and the heater assembly 228, an airflow may generally follow a flow path through the AHU 200 along which air may enter the first pressure zone 230 of the AHU 200 through the air inlet 214 located in the bottom side 204 of the AHU 200 where the air may successively encounter the blower assembly 220. The air may then be passed by the blower assembly 220 through the partition 218 and into the second pressure zone 232 where the air may successively encounter the heat exchanger assembly 222. The air may then pass through the heat exchanger assembly 222 to the third pressure zone 234, where the air may then encounter the heater assembly 228 and then successively exit the AHU 200 through the air outlet 216 located in the top side 202 of the AHU 200.

As previously stated, the various pressure zones 230, 232, 234 may be defined by the various components of the AHU 200 as an airflow flows through the fluid duct of the AHU 200. Most notably, it can be seen that when the blower assembly 220 is installed into the AHU 200, the partition 218 generally provides a zone boundary between a first pressure zone 230 of the AHU 200 and a second pressure zone 232 of the AHU 200. The first pressure zone 230 may generally be associated with the air inlet 214 and/or air input ports of the blower assembly 220 while the second pressure zone 232 may generally be associated with an output of the blower assembly 220 and which, in this embodiment, may generally be associated with an upstream portion of the heat exchanger assembly 222. The heat exchanger assembly 222 may generally provide a zone boundary between the second pressure zone 232 and a third pressure zone 234. The second pressure zone 232 may generally be associated with an upstream portion of the heat exchanger assembly 222, while the third pressure zone 234 may generally be associated with a downstream portion of the heat exchanger assembly 222, the heater assembly 228, and/or the air outlet 216.

The blower assembly 220 may generally create a relatively lower pressure at or near the air inlet 214 in the first pressure zone 230 as compared to a surrounding environmental pressure. As the blower assembly 220 passes air through the partition 218, the airflow entering the second pressure zone 232 may generally produce a relatively higher pressure. Additionally, a pressure differential may be created by passing the airflow through the heat exchanger assembly 222, and thus, the airflow may generally comprise an overall lower pressure in the third pressure zone 234 as compared to the second pressure zone 232. It will be appreciated that in some embodiments, the AHU 200 may be suitable for use in residential applications such as a heating and/or air conditioning system in an apartment, condominium, dwelling, or house. In other embodiments, however, AHU 200 may be used in commercial applications such as an HVAC system in a commercial, public, or industrial building or facility, or suitable other type of building or facility that distributes conditioned air.

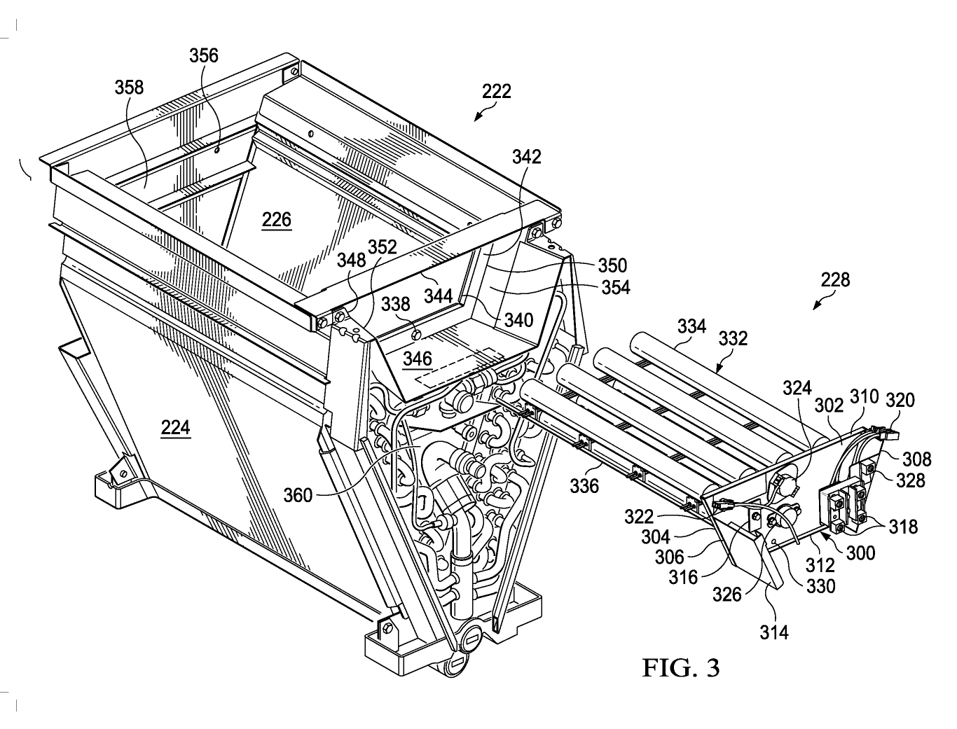

Referring now to FIG. 3, a partial exploded oblique view of a heat exchanger assembly 222 and a heater assembly 228 of the AHU of FIG. 2 is shown according to an embodiment of the disclosure. The heater assembly 228 may generally comprise a base plate 300 comprising a base plate front surface 302, a base plate rear surface 304, a base plate left side 306, a base plate right side 308, a base plate top surface 310, and a base plate bottom surface 312. The base plate 300 may generally be configured to carry a plurality of selectively removable electrical components. In some embodiments, the plurality of electrical components may comprise electrical terminals, contactors, resistors, capacitors, electrical connection plugs, electrical switches, and/or any other suitable electrical component required to operate the heater assembly 228. In some embodiments, the plurality of electrical components carried by the base plate 300 may comprise a contactor 316, terminal lugs 318, a high voltage plug 320, a low voltage plug 322, a non-cyclic thermal limit switch 324, a cyclic limit switch 326, and/or a ground lug 328. In some embodiments, at least some of the plurality of electrical components may be mounted to the base plate front surface 302. In other embodiments, at least some of the plurality of electrical components may be mounted to the base plate rear surface 304. In some embodiments, the base plate 300 may comprise an auxiliary mount 314 that may be attached to the base plate front surface 302 and may be configured to carry at least one of the plurality of electrical components. In the shown embodiment, the auxiliary mount 314 may carry at least the contactor 316. In other embodiments, however, the auxiliary mount 314 may carry the terminal lugs 318, a high voltage plug 320, a low voltage plug 322, a non-cyclic thermal limit switch 324, a cyclic limit switch 326, and/or a ground lug 328.

The base plate 300 may also be configured to carry a heater rack 332 and/or a plurality of heater elements 334. In some embodiments, the heater rack 332 may be carried by and/or mounted to the base plate rear surface 304. In some embodiments, mounting the heater rack 332 to the base plate rear surface 304 may comprise a plurality of fasteners that extend from the base plate front surface 302 through the base plate 300 to secure the heater rack 332 to the base plate rear surface 304. The heater rack 332 may additionally be configured to carry a plurality of heater elements 334 attached thereto. In some embodiments, the heater elements 334 may be disposed in a parallel configuration extending from the base plate rear surface 304. In some embodiments, the heater elements 334 may be disposed on a top side of the heater rack 332. In other embodiments, the heater elements 334 may be disposed on a bottom side of the heater rack 332. In yet other embodiments, the heater elements 334 may be disposed on both the top side and the bottom side of the heater rack 332. In alternative embodiments, the plurality of heater elements 334 may also be carried by and attached directly to the base plate 300.

The heat exchanger assembly 222 may generally be configured to carry the heater assembly 228. The heat exchanger assembly 222 may generally comprise a receiving aperture 340 configured to selectively receive the heater assembly 228. The receiving aperture 340 may generally be disposed between the left slab 224 and the right slab 226 of the heat exchanger assembly 222 such that the heater assembly 228 may be bounded laterally on a left side by the left slab 224 of the heat exchanger assembly 222 and bounded laterally on a right side by the right slab 226 of the heat exchanger assembly 222. The receiving aperture 340 may also be disposed substantially at a top end of the heat exchanger assembly 222 such that when the heater assembly 228 is received within the receiving aperture 340, an upper end of the heater assembly 228 may be located further upstream with respect to an airflow than the upper most ends of both the left slab 224 and the right slab 226 of the heat exchanger assembly 222. In some embodiments, the receiving aperture 340 may be disposed substantially at a top end of the heat exchanger assembly 222 such that when the heater assembly 228 is received within the receiving aperture 340, the heater assembly 228 may be disposed substantially adjacent to the air outlet, such as air outlet 216 of AHU 200.

The heat exchanger assembly 222 may also be configured to properly locate and/or align the heater assembly 228 within the receiving aperture 340. The heat exchanger assembly 222 may generally comprise a mounting face 342, a mounting top surface 344, a mounting bottom surface 346, a mounting left side 348, and a mounting right side 350. When the heater assembly 228 is properly received by the heat exchanger assembly 222, the base plate rear surface 304 of the base plate 300 of the heater assembly 228 may substantially abut the mounting face 342 of the heat exchanger assembly 222. In some embodiments, the mounting face 342 may comprise a substantially complimentary surface to the base plate rear surface 304 and/or a complimentary shape to the base plate 300. Additionally, the base plate top surface 310, the base plate bottom surface 312, the base plate left side 306, and/or the base plate right side 308 of the base plate 300 of the heater assembly 228 may substantially align with and/or substantially abut the mounting top surface 344, the mounting bottom surface 346, the mounting left side 348, and/or the mounting right side 350 of the heat exchanger assembly 222, respectively.

Furthermore, the heat exchanger assembly 222 may comprise a left mounting guide 352 and a right mounting guide 354. The left mounting guide 352 and/or the right mounting guide 354 may generally comprise an angled surface that tapers from the front of the heat exchanger assembly 222 towards the rear of the heat exchanger assembly 222 up to the mounting face 342 of the heat exchanger assembly 222. In some embodiments, the left mounting guide 352 and/or the right mounting guide 354 may interact with the base plate left side 306 and/or the base plate right side 308 of the base plate 300 of the heater assembly 228 to properly guide the heater assembly 228 into proper alignment with the heat exchanger assembly 222. Additionally, in some embodiments, the mounting bottom surface 346 may interact with the base plate bottom surface 312 of the base plate 300 of the heater assembly 228 to properly guide the heater assembly 228 into proper alignment with the heat exchanger assembly 222.

When the heater assembly 228 is properly received by the heat exchanger assembly 222, the base plate rear surface 304 of the base plate 300 of the heater assembly 228 may substantially abut the mounting face 342 of the heat exchanger assembly 222, and the base plate top surface 310, the base plate bottom surface 312, the base plate left side 306, and/or the base plate right side 308 of the base plate 300 of the heater assembly 228 may be substantially adjacent to and/or substantially abut the mounting top surface 344, the mounting bottom surface 346, the mounting left side 348, and/or the mounting right side 350 of the heat exchanger assembly 222, respectively. Additionally, in some embodiments, the heater rack 332 of the heater assembly 228 may comprise a plurality of heater alignment pins 336 that extend along a length of the heater rack 332. In some embodiments, the heater alignment pins 336 may extend beyond a rear portion of the heater rack 332. The heater alignment pins 336 may generally be configured to engage with and/or be received by heater alignment holes 356 that are disposed in a rear wall 358 of the heat exchanger assembly 222. Thus, in some embodiments, the heater assembly 228 may be properly aligned with the heat exchanger assembly 222 when the heater alignment pins 336 are substantially received within the heater alignment holes 356 of the heat exchanger assembly 222.

Furthermore, the base plate 300 of the heater assembly 228 may comprise a base plate mounting hole 330 that may be configured to substantially align with a heater mounting hole 338 in the heat exchanger assembly 222. In some embodiments, the base plate mounting hole 330 may be disposed in a lower portion of the base plate 300, while the heater mounting hole 338 may be disposed in a lower portion of the mounting face 342 and below the receiving aperture 340 of the heat exchanger assembly 222. In some embodiments, the heater mounting hole 338 may comprise a threaded surface, such that a fastener may be inserted through the base plate mounting hole 330 and threaded into the heater mounting hole 338 to selectively retain the heater assembly 228 in the receiving aperture 340 of the heat exchanger assembly 222. Thus, in some embodiments, the heater assembly 228 may be properly aligned with the heat exchanger assembly 222 when the base plate mounting hole 330 of the base plate 300 of the heater assembly 228 may be substantially aligned with the heater mounting hole 338 of the heat exchanger assembly 222.

Referring now to FIGS. 2-3, in operation, when the heater assembly 228 is properly received by and/or mounted within the heat exchanger assembly 222, the heater assembly 228 may generally be configured to heat an airflow that passes through the left slab 224 and/or right slab 226 and then subsequently over the heater elements 334 of the heater assembly 228. Moreover, in operation, the base plate 300 of the heater assembly 228 may generally be configured to form at least a portion of a fluid duct along the airflow path through the AHU 200. It will be appreciated that the portion of the fluid duct formed by the base plate 300 may also be referred to as a pressure barrier. Because the pressure within the third pressure zone 234 of the AHU 200 may be higher than the pressure external to the AHU 200 that is not within the airflow path, air flowing through the AHU 200 may attempt to escape through any portion of the airflow path that may not be sealed from the external environment. Accordingly, the rear wall 358 and the front wall 360 of the heat exchanger assembly 222 may form at least a portion of the fluid duct in the third pressure zone 234 at the rear and the front of the AHU 200, respectively. Additionally, the base plate 300 may be configured to form a fluid tight seal with the heat exchanger assembly 222 and form at least a portion of the fluid duct in the third pressure zone 234 at the front of the AHU 200. More specifically, the base plate rear surface 304 may interact with and/or substantially abut the mounting face 342 of the heat exchanger assembly 222 to prevent at least a portion of the airflow through the third pressure zone 234 of the AHU 200 from between the base plate rear surface 304 and the mounting face 342 to a location external to the heater assembly 228 and/or the heat exchanger assembly 222. In some embodiments, the base plate rear surface 304 may substantially abut the mounting face 342 to form the fluid duct. In some embodiments, the base plate 300 may comprise a gasket that may be inserted between the base plate rear surface 304 and the mounting face 342 to form the fluid duct. In some embodiments, the gasket may be formed from rubber, foam, and/or any other suitable adhesive and/or flexible gasket material that may prevent at least a portion of the airflow through the third pressure zone 234 of the AHU 200 from escaping between the base plate rear surface 304 and the mounting face 342.

Additionally, while the base plate rear surface 304 of the base plate 300 of the heater assembly 228 may substantially abut the mounting face 342 of the heat exchanger assembly 222 to form at least a portion of the fluid duct between the third pressure zone 234 of an airflow path of the AHU 200, and a location external to the heater assembly 228 and/or the heat exchanger assembly 222, it will be appreciated that the base plate top surface 310, the base plate bottom surface 312, the base plate left side 306, and/or the base plate right side 308 of the base plate 300 of the heater assembly 228 may be substantially adjacent to and/or substantially abut the mounting top surface 344, the mounting bottom surface 346, the mounting left side 348, and/or the mounting right side 350 of the heat exchanger assembly 222, respectively, to form at least a portion of the fluid duct and/or pressure barrier between the heater assembly 228 and the heat exchanger assembly 222.

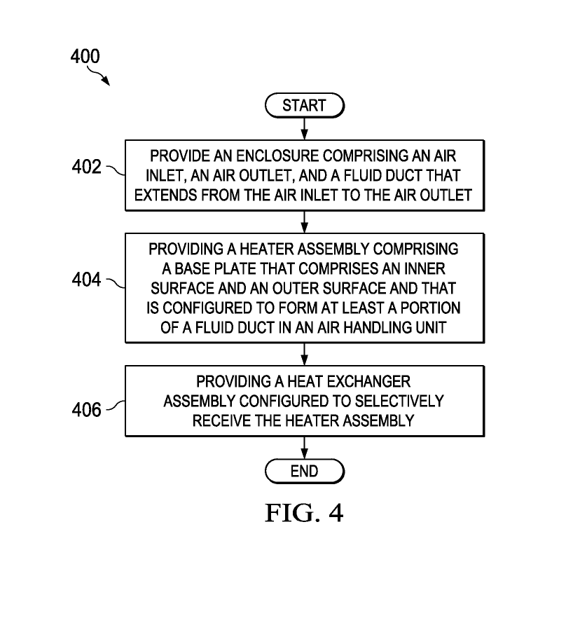

Referring now to FIG. 4, a flowchart of a method 400 of forming a fluid duct in an AHU is shown according to embodiments of the disclosure. The method 400 may begin at block 402 by providing an enclosure comprising an air inlet, an air outlet, and a fluid duct that extends from the air inlet to the air outlet. The method 400 may continue at block 404 by providing a heater assembly comprising a base plate that comprises an inner surface and an outer surface and that is configured to form at least a portion of a fluid duct in an air handling unit. The method 400 may continue at block 406 by providing a heat exchanger assembly configured to selectively receive the heater assembly. In some embodiments, the heater assembly may be heater assembly 228. In some embodiments, the heat exchanger assembly may be heat exchanger assembly 222. In some embodiments, the heater assembly may be disposed downstream from the heat exchanger assembly relative to an airflow passing through the fluid duct. In some embodiments, the heater assembly may be disposed between a left slab and a right slab of the heat exchanger assembly such that the base plate of the heater assembly interfaces with a substantially complimentary portion of the heat exchanger assembly. In some embodiments, the base plate may be configured to substantially mate to and/or abut a complimentary surface of the heat exchanger assembly.

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, Rₗ, and an upper limit, Rᵤ, is disclosed, any number falling within the range is specifically disclosed. In particular, the following numbers within the range are specifically disclosed: R=Rₗ+k*(Rᵤ-Rₗ), wherein k is a variable ranging from 1 percent to 100 percent with a 1 percent increment, i.e., k is 1 percent, 2 percent, 3 percent, 4 percent, 5 percent, . . . , 50 percent, 51 percent, 52 percent, . . . , 95 percent, 96 percent, 97 percent, 98 percent, 99 percent, or 100 percent. Unless otherwise stated, the term “about” shall mean plus or minus 10 percent of the subsequent value. Moreover, any numerical range defined by two R numbers as defined in the above is also specifically disclosed. Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present invention.

What is claimed is:

1. An air handling unit, comprising:
an enclosure comprising:
an air inlet;
an air outlet; and
a fluid duct that extends from the air inlet to the air outlet;
a heater assembly comprising a base plate that (1) comprises an inner surface and an outer surface and (2) is configured to form at least a portion of the fluid duct; and
a heat exchanger assembly configured to selectively receive the heater assembly.

2. The air handling unit of claim 1, wherein the heater assembly is carried by the heat exchanger assembly.

3. The air handling unit of claim 1, wherein the heater assembly is disposed between a left slab and a right slab of the heat exchanger assembly.

4. The air handling unit of claim 1, wherein the heater assembly is disposed downstream from the heat exchanger assembly with respect to airflow through the fluid duct.

5. The air handling unit of claim 1, wherein the heater assembly is disposed adjacent to the air outlet.

6. The air handling unit of claim 1, wherein the inner surface of the base plate is configured to form a fluid tight seal with a complimentary mounting surface of a heat exchanger assembly.

7. The air handling unit of claim 1, wherein the base plate is configured to carry a plurality of electronic components disposed on the outer surface of the base plate.

8. The air handling unit of claim 1, wherein the heater assembly comprises at least one heater element that is carried by the base plate and that is disposed within the fluid duct.

9. The air handling unit of claim 1, wherein the heater assembly comprises a heater rack that is attached to the base plate.

10. The air handling unit of claim 9, wherein the heater rack is configured to carry at least one heater element.

11. The air handling unit of claim 10, wherein the heater rack comprises at least one alignment pin.

12. The air handling unit of claim 11, wherein the heat exchanger assembly comprises at least one alignment pin hole that is configured to selectively receive the alignment pin.

13. A method of forming a fluid duct in an air handling unit, comprising:
providing an enclosure comprising an air inlet, an air outlet, and a fluid duct that extends from the air inlet to the air outlet;
providing a heater assembly comprising a base plate that (1) comprises an inner surface and an outer surface and (2) is configured to form at least a portion of a fluid duct in an air handling unit; and
providing a heat exchanger assembly configured to selectively receive the heater assembly.

14. The method of claim 13, further comprising:
disposing the heater assembly between a left slab and a right slab of the heat exchanger assembly.

15. The method of claim 13, further comprising:
disposing the heater assembly downstream from the heat exchanger assembly with respect to an airflow through the fluid duct.

16. The method of claim 13, further comprising:
disposing the heater assembly adjacent to the air outlet.

17. The method of claim 13, wherein the inner surface of the base plate is configured to form a fluid tight seal with a complimentary mounting surface of a heat exchanger assembly.

18. The method of claim 13, wherein the base plate is configured to carry a plurality of electronic components disposed on the outer surface of the base plate.

19. The method of claim 13, wherein the heater assembly comprises at least one heater element that is carried by the base plate and that is disposed within the fluid duct.

20. The method of claim 13, wherein the heater assembly comprises a heater rack that is attached to the base plate and that is configured to carry at least one heater element.
